(19) United States
(12) Patent Application Publication
(10) Pub. No.: US 2001/0033709 A1
(43) Pub. Date: Oct. 25, 2001

(54) Hybrid wavelength division multiplexer and add/drop device using fiber optic polarization independent couplers and bragg-evanescent-couplers

(76) Inventor: Stephen R. Mathis, Menifee, CA (US)

Correspondence Address: Donald E. Stout, Stout, Uxa, Buyan & Mullins, LLP, Suite 300, 4 Venture, Irvine, CA, 92618, US

(21) Appl. No.: 09/796,181

(22) Filed: Feb. 28, 2001

Related U.S. Application Data
(60) Provisional application No. 60/186,104, filed on Mar. 1, 2000.

(51) Int. Cl. G02B 6/28

(52) U.S. Cl. 385/24; 385/15

(57) ABSTRACT

Devices for use in optical telecommunication networks are described which are capable of efficiently adding and dropping a plurality of channels, operating over a plurality of optical passbands, and being separated by a plurality of channel spacings. To accommodate the vast numbers of combinations and permutations of channel types and spacings, the network architecture includes both PINC and BEC devices in order to optimize power transfer through a network. In a preferred embodiment, a 1×16 multiplexer with equal channel passbands and spacing includes a 2-tier PINC network, followed by a 4-tier BEC network. However, in another embodiment, the 2-tier PINC network can be extended to 7-tiers to achieve 128 channels, with a channel spacing of ≧4 nm. In yet another embodiment, each of these 7-tiers can be followed by a single BEC. The selection of the quantity and order of PINC's and BEC's is determined by the quantity of channels desired, the passband of each channel, the separation between each channel, and the required isolation between channels.

### BACKGROUND OF THE INVENTION

This invention relates generally to optical telecommunication network devices, and in particular to Wavelength Division Multiplexers (WDM) and add/drop devices.

Communication networks exhibit an insatiable desire for increased capacity. Every year, technological advances offer vast increases in transmission capacity, but new capabilities do not keep up with demand. Many researchers are currently developing new discrete optical devices aimed at improving transmission capacity, but optimum system architectures have been elusive.

The ability to increase fiber optic transmission capacity is limited by the capability to add more and more channels in a single optical fiber transmission window. The International Telecommunications Network Union (ITU) grid is rapidly becoming a standard, and typically specifies 200 Ghz, 100 Ghz, and 50 Ghz channel spacing, and is presently looking towards 25 Ghz spacing. With this in mind, there is a need for devices that can add or drop each of these channels to form a network. Some devices can now meet this requirement, and are promising Dense Wavelength Division Multiplexer (DWDM) networks of 80 or more channels in the 1.55 μm wavelength transmission window. However, these networks have not been optimized for optical power transmission.

Some devices, such as the fused biconic taper coupler WDM now offer low loss (e.g. 0.2 dB) polarization independent transmission, yet the channel spacing does not meet industry requirements. Other devices offer very high-resolution channel spacing (such as the fiber optic Bragg grating in the Mach-Zehnder configuration), but the losses associated with the devices are excessive. Furthermore, the ability to select particular wavelengths for a specific application, or to balance the power output from a multi-channel network, has not been demonstrated.

U.S. Pat. No. 5,121,453 discloses a “Polarization Independent Narrow Channel Wavelength Division Multiplexing Fiber Coupler and Method for Producing Same”. As discussed therein, fusion type couplers made with single mode fiber generally exhibit a dependence on polarization because of inherent birefringence, and the fraction of power coupled into each polarization is generally not the same. With this being the case, transmission of unpolarized light makes it unrealizable to fabricate an efficient low crosstalk WDM coupler if the birefringence effect is not mitigated.

The system in the '453 patent overcomes the general problem of polarization dependence by measuring the conditions when these devices become polarization independent, and reproducing those conditions during fabrication. Specifically, the patent explains that if the coupler elongation region made during the fusion process is drawn to a length where the envelope of power transfer cycles (referring to the power transferred between adjacent fibers) reaches a maximum, then complete coupling can be obtained independent of polarization.

Using this method, a Polarization Independent Coupler (PINC) can be fabricated that exhibits a channel crosstalk of less than −20 dB using narrow band laser sources with center wavelength spacing less than or equal to 35 nm. At present, their techniques have been advanced so that a center wavelength spacing of 4-5 nm can be made practicable. In addition, the excess loss of these devices has been reduced to approximately 0.2 dB. However, this device alone does not provide the channel spacing resolution that is provided by the present invention.

New systems now require much tighter spacing in order to achieve systems transmitting 80 or more channels in a single transmission band, i.e., the 1.55 μm band. Such a device has been achieved by Snitzer as disclosed in U.S. Pat. No. 5,457,758, and is comprised of a fusion biconic taper coupler and a fiber optic Bragg grating coupler, hereinafter defined as a Bragg-Evancescent-Coupler (BEC). The coupler relies on evanescent field coupling of light from one waveguide to the other, and the Bragg grating is disposed in the coupling region in each of the waveguides. The Bragg grating is reflective to a narrow band of light traversing the coupling region, and thus is capable of adding or dropping the desired channel.

At the present time, BEC devices have been demonstrated to achieve stable channel spacing on the ITU grid of 50 Ghz (0.4 nm). Since these are reflective devices, they can only be used following demultiplexing couplers.

BEC's work well for narrow channel spacing (1.6 nm or smaller), but are less effective for a channel spacing of 5 nm or more. Furthermore, by themselves, they would be quite inefficient in dropping or adding 80 channels in series, as the power level at the first drop would vary considerably from the power level at the last drop, since a 0.2 dB excess loss results from the signal traversing each device. The power level across the last device in this example would be down by 16 dB (80×0.2), from the power at the first device. Therefore, this device alone does not meet the performance of the present invention, which is designed to efficiently balance the optical power in any particular fiber optic network comprising a plurality of channels, and a plurality of channel spacings.

It would be advantageous to have a system with the ability to add or drop any channel, or selection of channels, on a fiber optic network as efficiently as possible. The term “efficiently” means the optimization of network architecture such that the excess losses of each channel are minimized, while the desired balance of power on each channel is achieved. It is noted that it may not be desired to equalize all output levels so that each channel has the same output power. Some channels may travel shorter distances, and thus require less power, some channels may require different power levels because they demand different Signal-to-Noise Ratios (SNR). Therefore, it is desired that that balance of power be controlled such that the optimum transmission condition for the overall network architecture is achieved. In addition, some passbands may be greater than others, or spaced at unequal intervals. It would thus be desirable to transmit all channel passbands with varying channel widths and spacings efficiently. Another advantageous feature would be to provide satisfactory isolation between channels, such as >30 dB. Two other desirable features would be to accommodate the demand for dense wavelength division channel spacing, and, finally, to develop a method for constructing an efficient fiber optic network using all optical fiber devices (vs. integrated optic or micro-optic devices), since all fiber devices are inherently simpler to manufacture, and to match the optical properties of the transmission media itself, potentially eliminating transmission losses at device interfaces.

### SUMMARY OF THE INVENTION

The present invention uniquely meets the objectives outlined above, and solves the problems in the prior art, by providing devices for use in optical telecommunication networks which are capable of efficiently adding and dropping a plurality of channels, operating over a plurality of optical passbands, and being separated by a plurality of channel spacings. To accommodate the vast numbers of combinations and permutations of channel types and spacings, the present invention includes a method for combining PINC and BEC devices to optimize power transfer through a network.

In the preferred embodiment, a 1×16 multiplexer is described with a 2-tier PINC network, followed by a 4-tier BEC network. However, in another embodiment, the 2-tier PINC network can be extended to 7-tiers to achieve 128 channels, with a channel spacing of ≧4 nm. In yet another embodiment, each of these 7-tiers can be followed by a single BEC. The selection of the quantity and order of PINC's and BEC's is determined by the quantity of channels desired, the passband of each channel, the separation between each channel, and the required isolation between channels.

In a particularly preferred embodiment, a 1×16 design with equal channel passbands and spacing is disclosed, but it is evidenced that the concept can be extended to other network configurations. The versatility of this invention uniquely meets its object to produce the desired optical transfer function for a particular network.

More particularly, in one aspect of the invention, there is provided a device for use in an optical telecommunication network, which comprises a sfirst PINC having an input for receiving channels comprising wavelength bands λ₁₋ₙ, where n is a number greater than 2, and a plurality of outputs for dividing the input channels, and a second PINC having an input for receiving a plurality of channels from one of the plurality of outputs of the first PINC. The second PINC has a plurality of outputs for further dividing the plurality of input channels. A third PINC includes an input for receiving a plurality of channels from another one of the plurality of outputs from the first PINC, and a plurality of outputs for further dividing the plurality of input channels.

Preferably, the inventive device further comprises a first BEC having a coupling region in which a Bragg grating is disposed, wherein the BEC has an input for receiving output from one of the second and third PINCs. A second BEC has an input for receiving output from one of the second and third PINCs. A third BEC may also be provided which includes an input for receiving output from one of the second and third PINCs, such that two of the aforementioned BECs are receiving output from one of the second and third PINCs, and a third one of the BECs is receiving output from the other of the second and third PINCs. Additional BECS may be employed to create additional BEC tiers, as desired, and to provide additional serially connected BECs in each tier.

In another aspect of the invention, there is provided a device for use in an optical telecommunication network, which comprises a PINC having an input for receiving channels comprising wavelength bands λ₁₋ₙ, where n is a number greater than 2, and a plurality of outputs for dividing the input channels. The inventive device further comprises a BEC having an input for receiving output from one of the plurality of outputs of the PINC. Additional tiers of BECs may be employed, as desired, to receive output channels from additional ones of the PINC outputs.

In still another aspect of the invention, there is provided a WDM network for use in an optical telecommunication network, comprising a PINC network comprised of a PINC having an input for receiving channels comprising wavelength bands λ₁₋ₙ, where n is a number greater than 2, and a plurality of outputs for dividing the input channels, and being further comprised of two tiers of PINCs, wherein each of the two tiers of PINCs has an input for receiving output from one of the plurality of outputs. The inventive WDM further comprises a BEC network comprised of a plurality of tiers of BECs, wherein each of the tiers of BECs has an input for receiving output from one of the tiers of PINCs. Preferably, the aforementioned plurality of tiers of BECs comprises four tiers of BECs, and each of the four tiers of BECs comprises at least two serially connected BECs.

The invention, together with additional features and advantages thereof, may best be understood by reference to the following description taken in conjunction with the accompanying illustrative drawing.

### BRIEF DESCRIPTION OF THE DRAWINGS

FIG. 1 is a schematic view of a prior art PINC device;

FIG. 2 is a schematic view of a BEC device constructed in accordance with the principles of the present invention;

FIG. 3 is a schematic view of a preferred embodiment of the present invention, namely, a 1×16 WDM network;

FIG. 4(a) is a schematic view of a first alternate splitter combination in accordance with the present invention, using a PINC device;

FIG. 4(b) is a schematic view of a second alternate splitter combination in accordance with the present invention, using a PINC device;

FIG. 4(c) is a schematic view of a third alternate splitter combination in accordance with the present invention, using a PINC device;

FIG. 5(a) is a schematic view of a first alternate add/drop combination using a BEC device;

FIG. 5(b) is a schematic view of a second alternate add/drop combination using a BEC device;

FIG. 5(c) is a schematic view of a third alternate add/drop combination using a BEC device;

FIG. 6 is an output transmission curve for PINC couplers such as those shown in FIG. 4(a);

FIG. 7 is an output transmission curve for output couplers such as those shown in FIG. 4(b);

FIG. 8 is a complete output transmission curve for two of the four outputs of 1×4 PINC couplers such as those illustrated in FIG. 4(b); and

FIG. 9 is a plot illustrating the relationship between the four PINC coupler output curves and the corresponding wavelengths of the preferred embodiment.

### DESCRIPTION OF THE PREFERRED EMBODIMENT

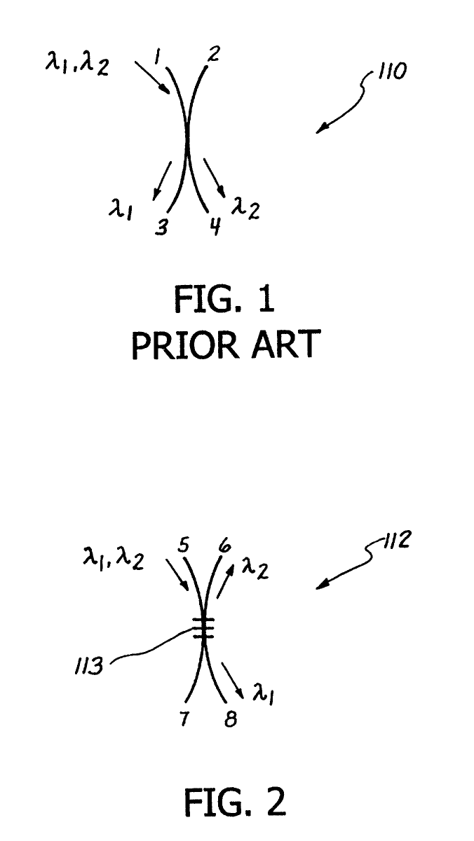

Referring now more particularly to the drawings, there is shown in FIG. 1 a PINC device 110. Such a device 110 comprises a basic element in a system constructed in accordance with the principles of the invention. A wavelength band comprising λ₁, λ₂ enters the port labeled 1, and is divided by the device such that λ₁ is coupled to the port labeled 3, and λ₂ is coupled to the port labeled 4. Typically, the wavelength bandwidth of each channel is 20 nm, but wavelength resolutions as narrow as 4 nm have been demonstrated in prior art systems, such as the one disclosed in U.S. Pat. No. 5,121,453, for example.

A second basic element of the invention is shown schematically in FIG. 2, wherein a BEC device 113 is illustrated. It is noted that these devices 112 operate in the reflective mode. As illustrated, a wavelength band comprising λ₁ and λ₂ enters the port labeled 5. However, the channel comprising λ₁ is coupled to port 8, and the channel comprising λ₂ is reflected back to port 6. The grating is designed to be a very efficient reflector for λ₂. However, λ₁ passes with very little loss, typically on the order of 0.2 dB.

In the configuration illustrated in FIG. 2, the BEC device 112 is uniquely constructed of two optical fibers, each pulled to a fine cross-section, with a Bragg grating disposed at the junction between the two fibers. The coupler itself, which comprises the BEC device, may be either a PINC coupler or a tap (broadband) coupler, as desired.

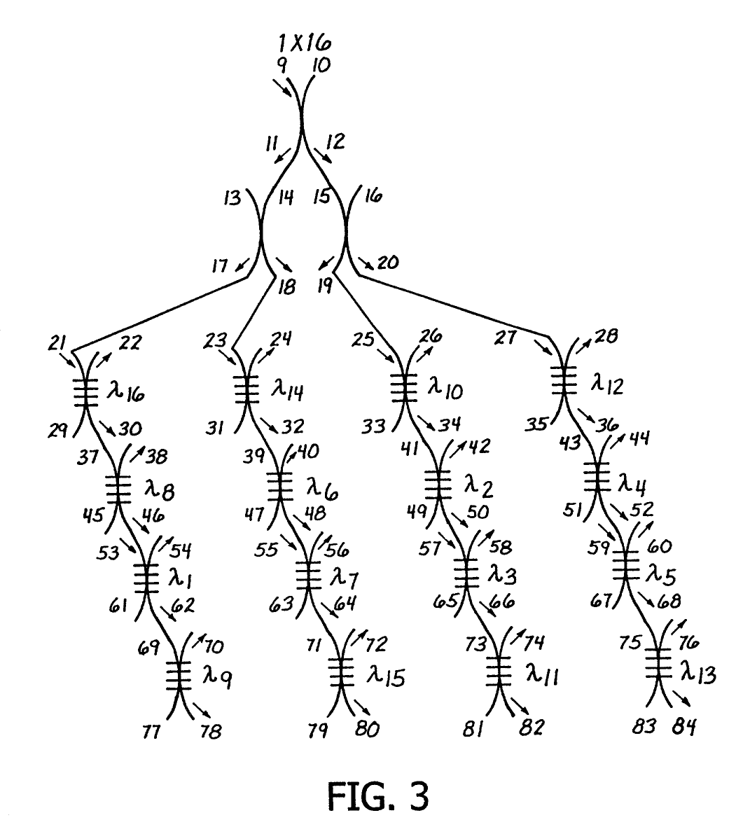

Now, the presently preferred embodiment combines the devices 110 and 112 to form a 1×16 WDM network 114. Referring to FIG. 3, channels comprising wavelengths λ₁₋₁₆ enter the input port, labeled 9, and continue down the PINC dividing network to the input of the BEC networks at ports 21, 23, 25, and 27. Each of these BEC networks contain four BEC devices, and couple four channels from the network, via ports 22, 38, 54, and 70 on the first leg, ports 24, 40, 56, and 72 on the second leg, ports 26, 42, 58, and 74 on the third leg, and ports 28, 44, 60, and 76 on the fourth leg.

In the preferred embodiment, the center wavelength and passbands of the PINC couplers, and the center wavelength and passbands of each BEC have been arranged to optimize transmission loss through the network for sixteen equally spaced channels. However, if it is desired that non-equally spaced channels be specified, alternate structures are easily accommodated with this architecture. A computer model is used to determine the optimum configuration of passbands and center wavelengths for each device for any arbitrary configuration. Present devices offer the ability to add or drop 80 or more channels. It should be noted that in the preferred embodiment, the wavelength centers of each BEC device do not follow an intuitive pattern. In each case, arranging the sinusoidal wavelength transmission dependencies of each device in a particular order using a computer model optimizes the transmission.

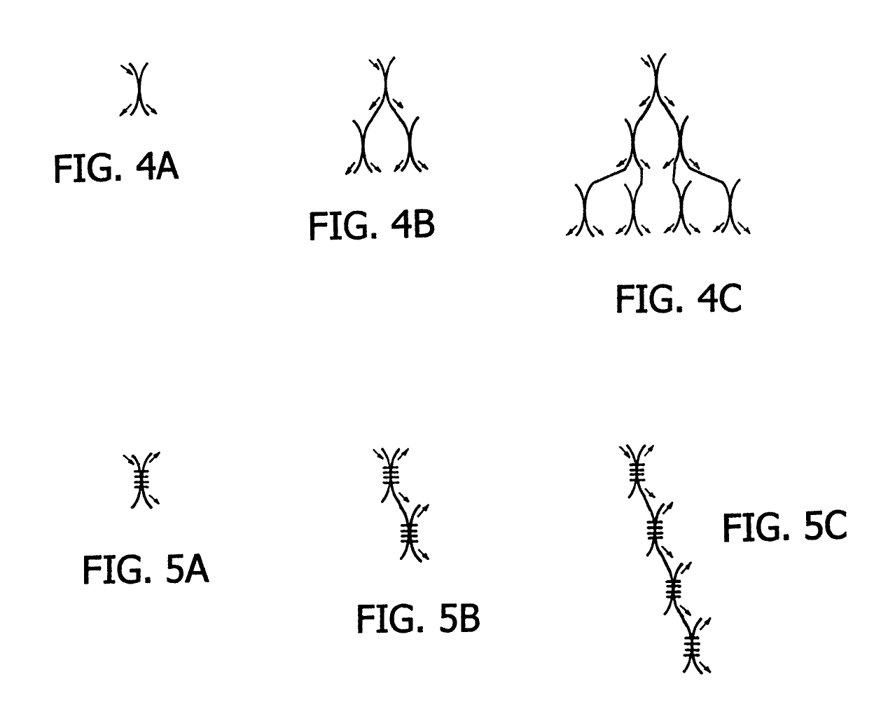

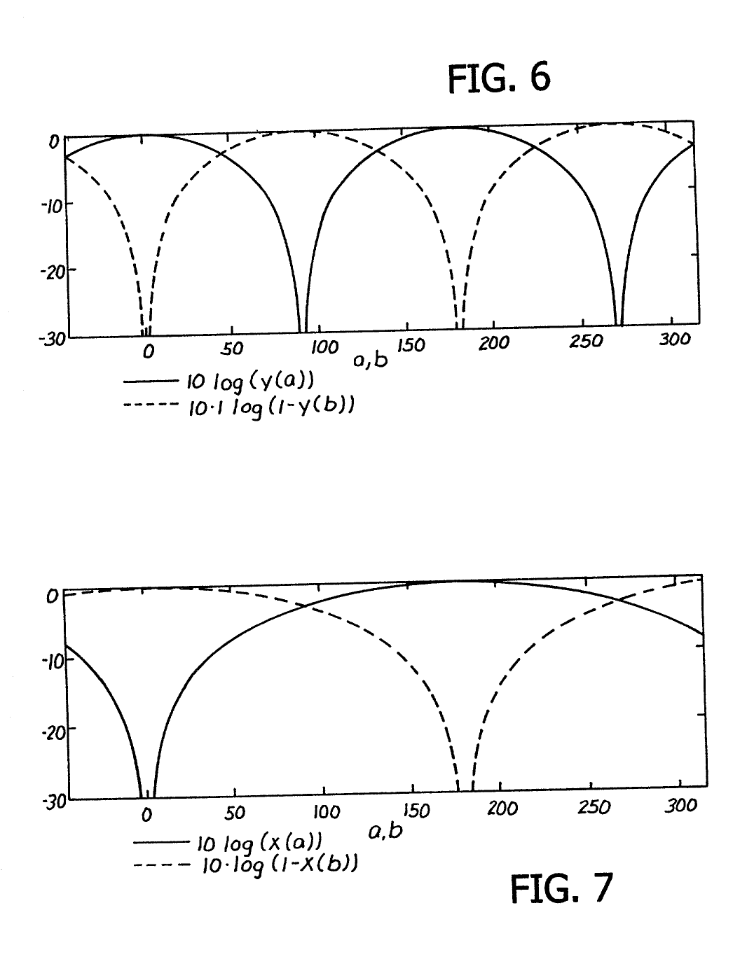

The optimization process is illustrated in FIGS. 6-9. The transmission of a single 1×2 coupler (as shown in FIGS. 1 and 4(a)) is illustrated in FIG. 6 in which transmission is plotted as a function of wavelength. The solid line corresponds to one of the output legs and the dashed line corresponds to the other. It is assumed that these curves are generally in the Kπ phase region as described in U.S. Pat. No. 5,121,453 to maintain polarization independence. It can also apply to the region prior to the first waist in the polarization envelope.

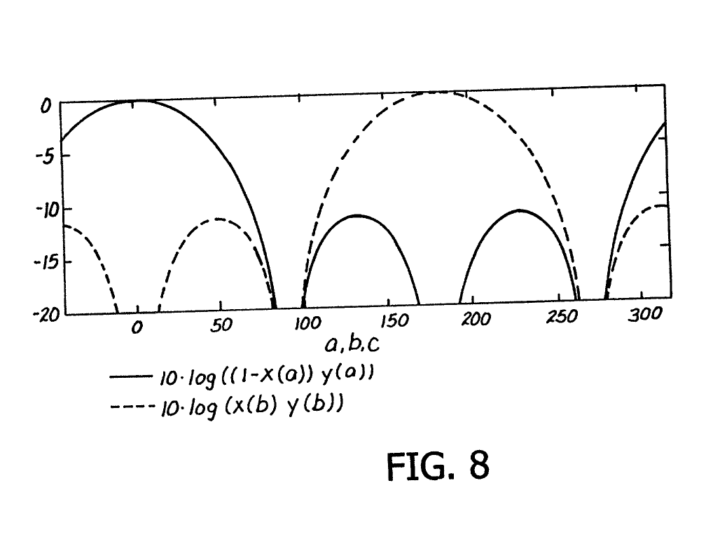

The transmission of one of the next two couplers (i.e. the two parallel couplers shown in FIG. 4(b)) is illustrated in FIG. 7, where again the solid and dashed lines correspond to the transmission of each of the two outputs. It should be noted that this shows only a short section of the more complex curve described in the prior art. The complete transmission curve for a pair of outputs from a 1×4 coupler as shown in FIG. 4(b) is illustrated in FIG. 8. It is the product of the curves from FIG. 6 and FIG. 7. This curve illustrates the prior art where the period or change in wavelength between successive peaks is twice that of the first coupler and the phase between the curves is adjusted to produce this result.

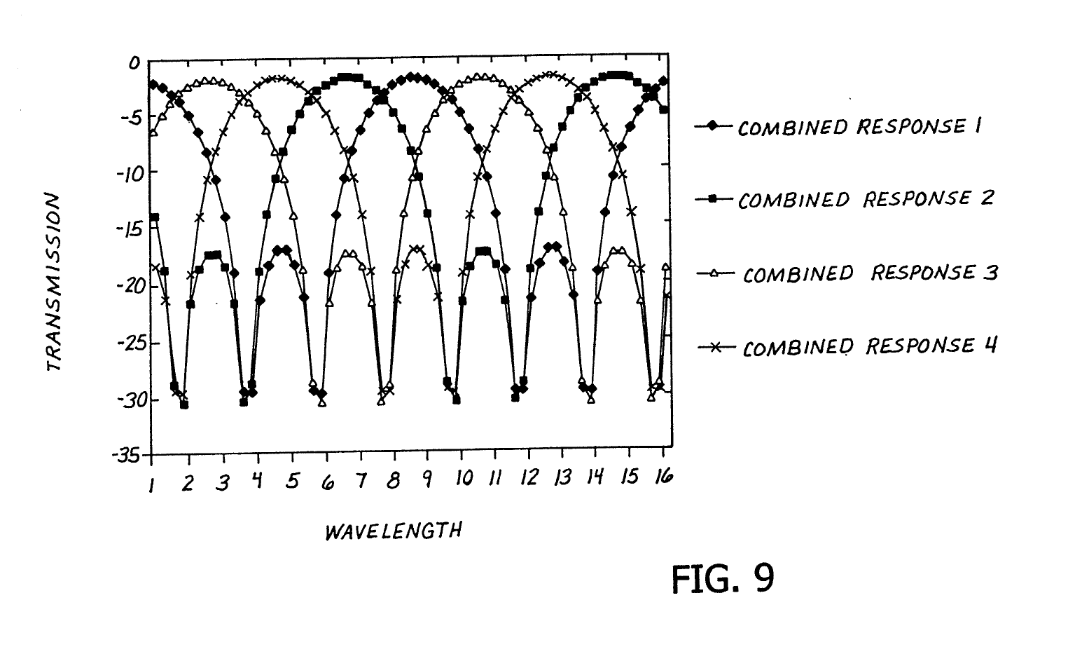

In the present invention, unlike the prior art, the period and phase relationship is determined by an optimization process normally performed using a computer. Any optimization algorithm that produces an acceptable result can be used. Furthermore, in the present invention, more than one peak or cycle of a transmission curve from a particular output may be used. A typical result is illustrated in FIG. 9. Each of the four transmission curves from a 1×4 configuration (FIG. 4(b)) are plotted together. The sixteen wavelengths of interest are indicated. These wavelengths correspond to the wavelength values indicated in FIG. 3. Each of the strings of BEC couplers in FIG. 3 is associated with one of the curves in FIG. 9. It should be noted that the channel isolation is dependent upon the BEC properties as well as the PINC transmission curve.

In a reversible fashion, channels can be added to the network by placing λ₁₆, λ₈, λ₁ and λ₉ wavelength sources at ports 22, 38, 54, and 70, for example, and similarly for the other three legs. In the reverse case (in the add mode), signals are reflected from the BEC, and travel back to the input port, labeled 9. Therefore, this network can be used to demultiplex (drop) or multiplex (add), or any combination thereof, on or off the network.

Alternatively, FIGS. 4(a), 4(b), and 4(c) show that PINC devices can be configured in any multiple of tiers. Likewise, FIGS. 5(a), 5(b), and 5(c) illustrate that BEC devices can be configured so that any number of devices occur in a single chain. These alternate structures can be used to configure asymmetric network architectures, and optimize their transmission quality, i.e., loss, channel bandwidth, and isolation characteristics. For example, referring to FIG. 3, it is possible to use channels that could exit from ports 78, 80, 82, and 84, even though they are not reflected by any BEC device, and therefore do not benefit from a BEC's channel selectivity. Channels that do not require high isolation could be coupled to these ports. This offers a unique advantage over other network architectures in that the optical power is easily balanced throughout the network. Channels demanding high signal strength, and low insertion loss, can be added or dropped in chains with a short series of PINCs and BECs, or only one. Other less sensitive channels can be divided using a plurality of PINC and BEC devices.

Modern optical telecommunication networks require a device that is capable of efficiently adding and dropping a plurality of channels, operating over a plurality of optical passbands, and being separated by a plurality of channel spacings. To accommodate the vast numbers of combinations and permutations of channel types and spacings, the present invention is a network architecture that combines efficient, low loss PINC and BEC devices to optimize power transfer through a network, for both uniform and arbitrary channel specifications, i.e., center wavelength and passband.

This invention uniquely meets the requirements to add or drop any channel, or selection of channels, on a fiber optic network as efficiently as possible. The network architecture is optimized via computer modeling such that the excess losses of each channel are minimized, while the desired balance of power on each channel is achieved.

Additionally, this invention uniquely has the ability to balance the power of each channel, as desired, such that the optimum transmission condition for the overall network architecture is achieved. For example, the 1×16 WDM network of FIG. 3 balances the power between outputs to within a few tenths of one dB while a string of sixteen BEC devices will have a 3 dB loss difference between the first and last device. This effect grows with size. A string of 80 BEC devices will have a 16 dB loss difference, while a 1×80 WDM network, constructed in accordance with the principles of the present invention, will have uniformity within 2 or 3 dB.

Isolation between channels, i.e., >30 dB is achieved by selecting which channels will be coupled on or off of the network using a BEC, and by specifying the bandwidths of each PINC and BEC in the network. For example, dense wavelength division channel spacing is achieved by selecting all narrow band devices. Finally, this invention teaches a method for constructing an efficient fiber optic network using all optical fiber devices (vs. integrated optic or micro-optic devices). Since all fiber devices are inherently simpler to manufacture, and match the optical properties of the transmission media itself, this invention minimizes transmission losses at device interfaces.

Accordingly, although an exemplary embodiment of the invention has been shown and described, it is to be understood that all the terms used herein are descriptive rather than limiting, and that many changes, modifications, and substitutions may be made by one having ordinary skill in the art without departing from the spirit and scope of the invention. It is intended that the scope of the invention be limited not by this detailed description, but rather only by the claims appended hereto.

What is claimed is:

1. A device for use in an optical telecommunication network, comprising:
a first polarization independent coupler (PINC) having an input for receiving channels comprising wavelength bands λ₁₋ₙ, where n is a number greater than 2, and a plurality of outputs for dividing the input channels; and
a second PINC having an input for receiving a plurality of channels from one of the plurality of outputs of the first PINC, said second PINC having a plurality of outputs for further dividing the plurality of input channels.

2. The device as recited in claim 1, and further comprising a third PINC having an input for receiving a plurality of channels from another one of the plurality of outputs from the first PINC, said third PINC having a plurality of outputs for further dividing the plurality of input channels.

3. The device as recited in claim 2, and further comprising a first Bragg-Evanescent-Coupler (BEC) having a coupling region in which a Bragg grating is disposed, said BEC having an input for receiving output from one of said second and third PINCs.

4. The device as recited in claim 3, and further comprising a second BEC having an input for receiving output from one of said second and third PINCs.

5. The device as recited in claim 4, and further comprising a third BEC having an input for receiving output from one of said second and third PINCs, such that two of said BECs are receiving output from one of said second and third PINCs, and a third one of said BECs is receiving output from the other of said second and third PINCs.

6. The device as recited in claim 5, and further comprising a fourth BEC having an input for receiving output from one of said second and third PINCs, such that two of said BECs are receiving output from one of said second and third PINCs, and the other two of said BECs are receiving output from the other of said second and third PINCs.

7. The device as recited in claim 3, and further comprising a second BEC having an input for receiving output from said first BEC.

8. The device as recited in claim 4, and further comprising a third BEC having an input for receiving output from one of said first and second BECs.

9. The device as recited in claim 8, and further comprising a fourth BEC for receiving output from the other of said first and second BECs.

10. The device as recited in claim 7, and further comprising a third BEC having an input for receiving output from said second BEC.

11. A device for use in an optical telecommunication network, comprising:
a PINC having an input for receiving channels comprising wavelength bands λ₁₋ₙ where n is a number greater than 2, and a plurality of outputs for dividing the input channels; and
a BEC having an input for receiving output from one of the plurality of outputs of said PINC.

12. The device as recited in claim 11, and further comprising a second BEC having an input for receiving output from another of the plurality of outputs of said PINC.

13. The device as recited in claim 12, and further comprising a third BEC having an input for receiving output from one of the first and second BECs.

14. The device as recited in claim 13, and further comprising a fourth BEC having an input for receiving output from the other of the first and second BECs.

15. The device as recited in claim 11, and further comprising a second BEC having an input for receiving output from said BEC.

16. A Wavelength Division Multiplexer (WDM) network for use in an optical telecommunication network, comprising:
a PINC network comprised of a PINC having an input for receiving channels comprising wavelength bands λ₁₋ₙ, where n is a number greater than 2, and a plurality of outputs for dividing the input channels, and being further comprised of two tiers of PINCs, each of said two tiers of PINCs having an input for receiving output from one of said plurality of outputs; and
a BEC network comprised of a plurality of tiers of BECs, each of said tiers of BECs having an input for receiving output from one of said tiers of PINCs.

17. The WDM network as recited in claim 16, wherein said plurality of tiers of BECs comprises four tiers of BECs.

18. The WDM network as recited in claim 17, wherein each of said four tiers of BECs comprises at least two serially connected BECs.
